(19) United States
(12) Patent Application Publication
(10) Pub. No.: US 2004/0060043 A1
(43) Pub. Date: Mar. 25, 2004

(54) Method and apparatus for instrumentation ON/OFF

(76) Inventors: George P. Frysinger, Westminster, CO (US); Stephen E. Buck, Boulder, CO (US); Burt Wagner, Niwot, CO (US); Richard A. Schmelzer, Boulder, CO (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/622,782

(22) Filed: Jul. 21, 2003

Related U.S. Application Data
(60) Provisional application No. 60/397,294, filed on Jul. 19, 2002.

(51) Int. Cl. G06F 9/45; H02H 3/05

(52) U.S. Cl. 717/158; 714/35

(57) ABSTRACT

In embodiments of the invention, modules or other application components of a software application are instrumented. That is, monitoring code is inserted into application components that forms the software application. The inserted instructions, for example, can cause data such as execution times, call return times, resources used, or other performance metrics to be recorded for that application component and optionally reported. Advantageously, embodiments of the invention enable features of the instrumentation to be turned OFF (i.e., deactivated) where the performance of systems executing the instrumented software is outside of predetermined operational limits.

### CROSS REFERENCE TO RELATED APPLICATIONS

This application claims the benefit of and priority to commonly owned and assigned U.S. provisional application No. 60/397,294, filed Jul. 19, 2002, the disclosure of which is incorporated herein by reference in its entirety.

### COPYRIGHT

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The invention relates to software architectures. In particular, but not by way of limitation, the invention relates to systems and methods for instrumenting software.

### BACKGROUND OF THE INVENTION

Instrumentation involves the insertion of devices or instructions into hardware or software to monitor operations of the corresponding systems, applications, or components thereof. In software, instrumentation involves inserting code to monitor performance metrics of the entire application, or portions thereof. For example, instrumentation instructions can be inserted into each module of a software application.

Known systems and methods for instrumenting software have many disadvantages, however. For example, instrumentation instructions and their execution generally require substantial overhead. In particular, when running, instrumentation code can consume substantial amounts of available memory, bandwidth, and processor time. This type of resource consumption may be acceptable in a pre-deployment testing environment, but it is generally not acceptable in a post-deployment run-time environment. Accordingly, instrumentation is not widely used in post-deployment environments, even though the recorded performance metrics could be beneficial.

What is needed is a technique for providing software instrumentation in post-deployment environments in a way that manages the potentially negative effects on operational overhead.

### SUMMARY OF THE INVENTION

Exemplary embodiments of the invention shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

In embodiments of the invention, modules or other application components of a software application are instrumented. That is, monitoring code is inserted into application components that form the software application. The inserted instructions, for example, can cause data such as execution times, call return times, resources used, or other performance metrics to be recorded for that application component and optionally reported. Advantageously, embodiments of the invention enable features of the instrumentation to be turned OFF (i.e., deactivated) where the performance of systems executing the instrumented software is outside of predetermined operational limits.

### BRIEF DESCRIPTION OF THE DRAWINGS

Various objects, advantages, and a more complete understanding of the invention are apparent and more readily appreciated by reference to the following Detailed Description and to the appended claims when taken in conjunction with the accompanying Drawings wherein:

FIG. 1A is a process flow diagram for manually instrumenting software, according to one embodiment of the invention;

FIG. 1B is a process flow diagram for dynamically instrumenting software, according to one embodiment of the invention; FIG. 2 is a process flow diagram for initializing an instrumented architecture, according to one embodiment of the invention;

FIG. 3 is a functional block diagram illustrating an instrumented software architecture, according to one embodiment of the invention;

FIG. 4 is a process flow diagram for setting an activation/deactivation switch, according to one embodiment of the invention;

FIG. 5 is a process flow diagram for monitoring the performance of application code, according to one embodiment of the invention; and

FIG. 6 is a process flow diagram for dynamically switching the instrumentation ON or OFF, according to one embodiment of the invention.

### DETAILED DESCRIPTION

The following detailed description describes exemplary embodiments of processes for instrumenting software in the first instance, a software instrumentation architecture, and processes for executing instrumented software in a run-time environment. This section concludes with a discussion of some of the benefits of the described instrumentation architecture and processes.

While sub-headings are used in this section for organizational convenience, the disclosure of any particular feature(s) is/are not necessarily limited to any particular section or sub-section of this specification.

### Processes for Instrumenting Software

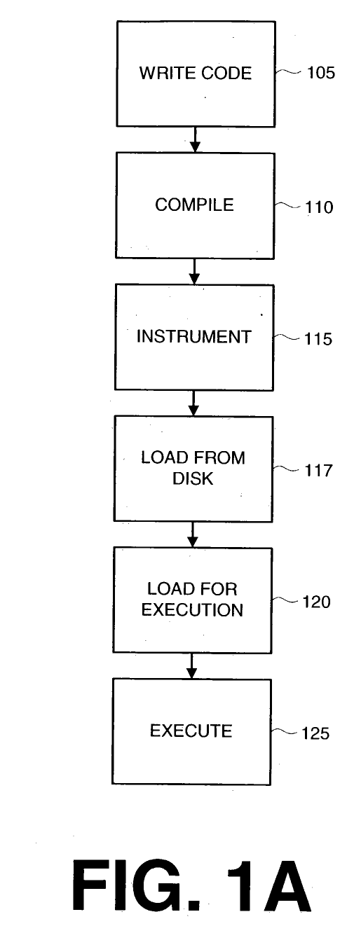

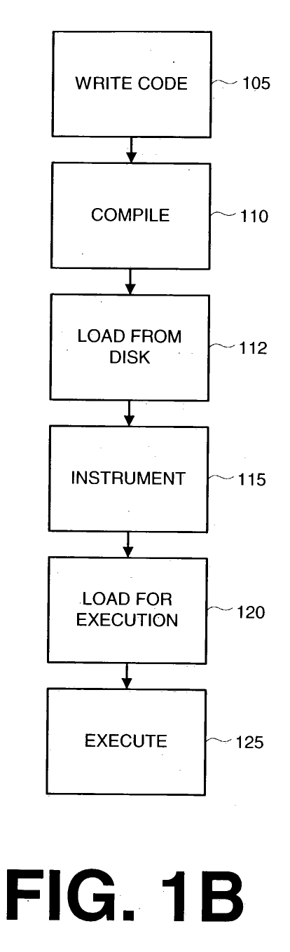

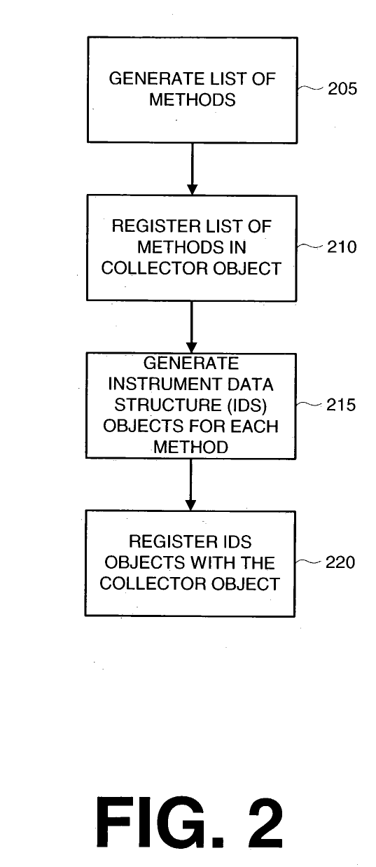

Instrumentation can be performed manually or dynamically, as discussed below with reference to FIGS. 1A and 1B, respectively.

FIG. 1A is a process flow diagram for manually instrumenting software, according to one embodiment of the invention. As shown therein, an instrumentation process may begin by writing code in step 105. Next, the code is compiled in step 110 and instrumented in step 115, as will be described in more detail below. After instrumentation step 115, the instrumented code is loaded from disk in step 117, loaded for execution in step 120, and executed in step 125.

The sequence illustrated in FIG. 1 is advantageous because the instrumentation step 115 operates on compiled code. In other words, as shown, instrumentation does not require access to source code that is output from code writing step 105.

The process illustrated in FIG. 1 is applicable to object-oriented software environments. Where Java is used, for example, a programmer may write source code in step 105 using a text editor and save the source code to a java file. In step 110, the source code is compiled by the Java compiler into object code contained in a separate .class file. In step 115, a user manually modifies .class files with additional byte codes for all .class files that that have been identified for instrumentation. The .class files are a set of byte codes that are a standardized sequence of instructions. In order to “run”, or “execute” the instructions represented by the byte codes, the file must be loaded into a Java Virtual Machine (“VM”) in step 120, then executed by that VM in step 125. VM's have been created on virtually all operating systems.

FIG. 1B is a process flow diagram for dynamically instrumenting software, according to one embodiment of the invention. As shown therein, an instrumentation process may begin by writing code in step 105, and compiling the code in step 110. In this dynamic implementation, code is automatically loaded from disk in step 112 and automatically instrumented according to a predetermined class/filter mechanism that identifies which class(es) or method(s) are to be instrumented. The instrumented code is loaded for execution in step 120, and executed in step 125.

According to embodiments of the invention, instrumentation process 115 causes a series of processes to be performed in execution step 125, which initialize an instrumented architecture within a run-time application.

FIG. 2 is a process flow diagram for initializing an instrumented architecture, according to one embodiment of the invention. As shown therein, the process begins by generating a list of methods in step 205. Accordingly, a class may be defined to include all objects having the same method. In the alternative, methods may be selected based on a particular content in which the methods are used.

In step 210, the process registers the list of selected methods in a collector object, for example as object variables. Then, instrument data structure (IDS) objects are generated for each method in step 215. Finally, each of the generated IDS objects are registered with the collector object in step 220. The process illustrated in FIG. 2 may be repeated for multiple classes or methods.

Although the initialization process in FIG. 2 is described for a JAVA environment, alternative initialization processes can be used for Java or other program environments, so long as code is generated to perform the functions described herein with reference to the collector object and IDS objects.

### A Software Instrumentation Architecture

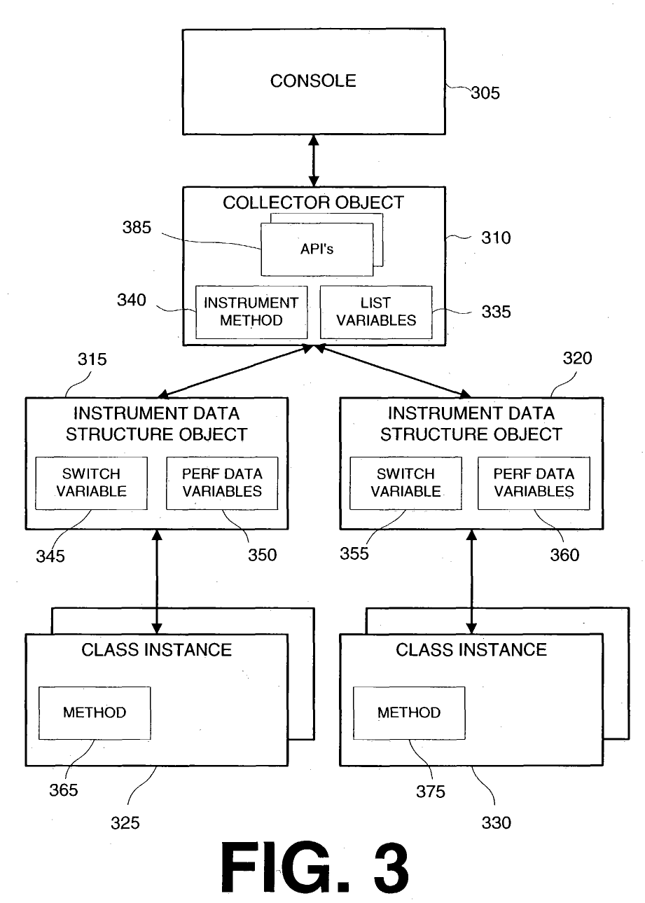

FIG. 3 is a functional block diagram illustrating an instrumented software architecture, according to one embodiment of the invention. As shown therein, a console 305 is in communication with a collector object 310. Collector object 310 is message-linked with IDS objects 315 and 320. IDS object 315 is message-linked with class instance 325, and IDS object 320 is message-linked with class instance 330. Collector object 310 and IDS objects 315 and 320 enable instrumentation features for (application) class instances 325 and 330, as will be described below.

As used herein, objects and methods are code. An object is a bundle of one or more variables and/or methods, a variable indicative of a state (such as a data item), and a method being associated with behavior (i.e., an executable process). As also used herein, a class defines a group of variables or methods that are common to a group of objects, at least within a given context.

Collector object 310 includes instrument method 340, list variables 335, and Application Program Interfaces (API's) 385. API's 385 may be methods. IDS object 315 includes switch variable 345 and performance data variables 350, and IDS object 320 includes switch variable 355 and performance data variables 360. Class instance 325 includes methods 365 and 370, and class instance 330 includes methods 375 and 380.

Collector object 310 is loaded into the VM of a particular java-based managed resource (Tomcat, WebLogic, JBoss, etc.) on startup of that resource. Collector object 310 provides a common access point to the performance information associated with instrumented methods 365, 370, 375, and 380. List variables 335 store a list of classes and methods that have been instrumented, as well as the IDS objects associated with each method so instrumented. API's 385 provide access to the list variables 335. The API's 385 are used primarily by the Console 305. For example, when the console 305 wishes to identify those methods that have been instrumented, it contacts the collector 310 via the API's 385 in order to retrieve performance data from the list variables 335. The data from list variables 335 can then be displayed on the console 305. Instrument method 340 is used for messaging between collector object 310 and IDS objects 315 and 320.

IDS objects 315 and 320 exist in the same VM as collector object 310. There is one IDS object for each instrumented method. For example, as shown, IDS object 315 is associated with method 365. Likewise, IDS object 320 is associated with method 375. In this instance, performance data variables 350 maintain performance data measured by method 365, and performance data variable 360 maintains performance data measured by method 375. In addition, in accordance with the associations above, switch variable 345 maintains the state of an activation/deactivation switch for method 365, and switch variable 355 maintains the state of an activation/deactivation switch for methods 375.

Alternative software instrumentation architectures are also possible. For example, the quantities of IDS objects, class objects, and methods can be varied according to design choice. In addition, analogical architectures can be implemented in other software languages, including other than object-oriented environments.

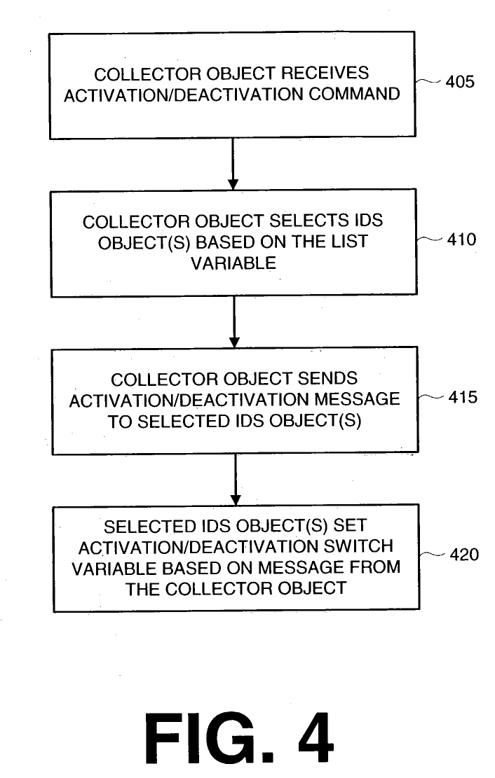

The operation of the architecture in FIG. 3 is described, at least in part, with reference to FIGS. 4, 5, and 6.

### Processes For Executing Instrumented Software

To limit the performance impact of executing post-deployment instrumentation instructions, in one embodiment of the present invention, a user can activate or deactivate, i.e., turn ON or OFF, the instrumentation instruction sets associated with any or all of the application components. In other words, recording of performance metrics can be stopped and started on demand for some or all of the application components. Notably, activation and deactivation of a set of instrumentation instructions can be done while the software application is running.

FIG. 4 is a process flow diagram for setting an activation/deactivation switch, according to one embodiment of the invention. As shown therein, the process begins in step 405 when the collector object 310 receives an activation/deactivation command targeting one or more instrumented methods 365, 370, 375 and 380. In step 410, collector object 310 selects one or more IDS objects 315 and/or 320 based on the association of instrumented methods to IDS objects in list variable 335. Subsequently, in step 415, the collector object 310 sends an activation/deactivation message to the selected IDS object(s) using instrument method 340, for example. In step 420, the selected IDS object(s) set an activation/deactivation switch variable according to the message sent by the collector object 310.

For example, with reference to FIG. 3, if collector 310 received a message to deactivate the instrumentation of a class including methods 370 and 380, then, in accordance with the associations described above, the collector object 310 would send a deactivation message to IDS 320, where switch variable 355 would be set to OFF.

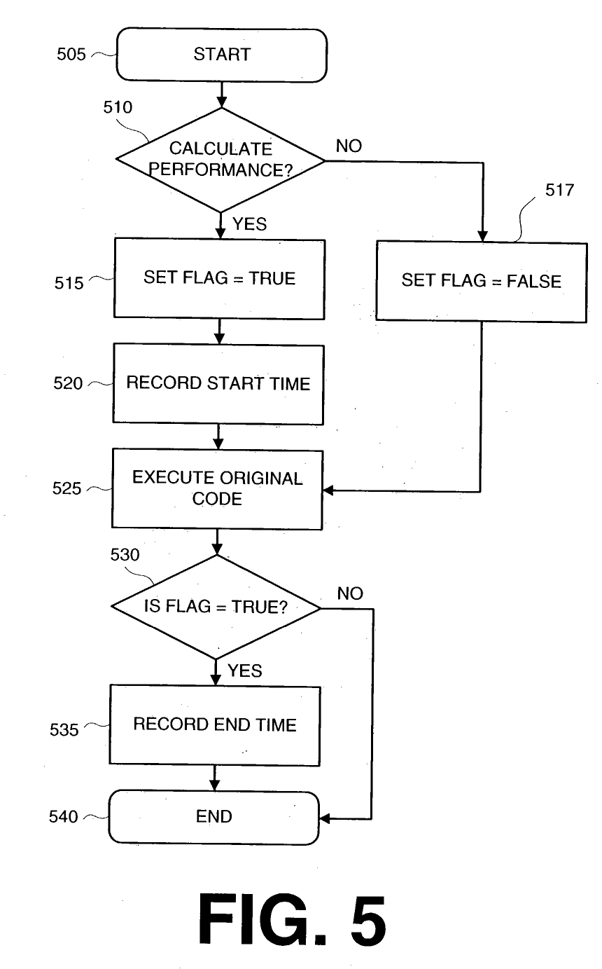

Thus, FIG. 4 provides a method for turning switch variables ON and OFF according to commands received in the collector object. FIG. 5 describes how the state of switch variables can be exploited by instrumented methods.

FIG. 5 is a process flow diagram for monitoring the performance of application code, according to one embodiment of the invention. As shown therein, the process begins in step 505 and advances to conditional step 510 to determine whether to calculate a performance metric. A method can make such a determination simply by reading the state of a switch variable. If the determination is in the affirmative, the process advances to step 515 to set an internal flag equal to TRUE. Then, in step 520, the process records a start time before advancing to step 525 to execute the original (application) code having the embedded instrumentation. The start time may be recorded, for example, using a message call to a timer (not shown in FIG. 3). Where the determination in step 510 is in the negative, the process sets the internal flag to FALSE in step 517, then advances to step 525 to execute the original code without instrumentation.

Next, in conditional step 530, a determination is made as to whether the internal flag is TRUE. Where the determination is made in the affirmative, the process advances to step 535 to record the end time (again using a message call to a timer) before terminating in step 540. If, however, the output of conditional step 530 is in the negative, the process advances directly to termination step 540 without executing recordation step 535.

Note that the test for whether performance timing should be made is done both at the start and the end of the process, in conditional steps 510 and 530, respectively. One can think of it “wrapping” the method. A similar approach is provided in the pseudo-code below:

class myClass {

// Added by Xaffire
CODE HERE TO DETERMINE WHICH METHODS TO INSTRUMENT,
INITIALIZE COLLECTOR, AND CREATE ONE DATA INSTRUMENT
STRUCTURE FOR EACH METHOD
public void myMethod {

// “Safety Net” Added by Xaffire
try {

// Determine if performance measurement has been
// dynamically turned off
if ( DataInstrumentStructure.performMeasurement ) {

shouldPerformMeasurement = TRUE
startTime = XaffireTimer.getTime( )

}

catch (XaffireException e ) {
}
// Original programmer code here
// End of original programmer code
// “Safety Net” Added by Xaffire
try {

// Note the test is now in-process, instead of out of
// process
if ( shouldPerformMeasurement ) {

endTime = XaffireTimer.getTime( )
Collector.update( endTime − startTime, performanceData

)

}

catch (XaffireException e ) {
}

}

Activation and deactivation of a set of instrumentation instructions can be performed manually or automatically. For example, a user can select which application components should be monitored, i.e., which set of methods should be activated. Similarly, the user can select which application components should not be monitored. In the manual case, the activation/deactivation command received at collector object 310 in step 405 can originate from console 305.

Alternatively, in an automatic mode, a controller can monitor the performance of the computer system on which the application is running and activate or deactivate a set of instrumentation instructions based on that monitoring. In other words, when the performance of the computer system or software application reaches a predetermined threshold, instrumentation instructions can be activated or deactivated.

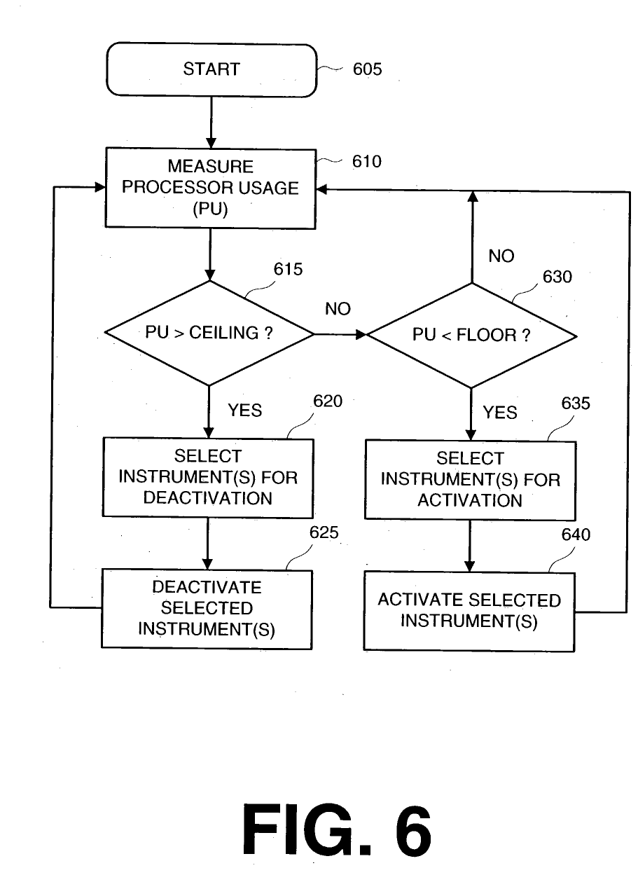

FIG. 6 is a process flow diagram for dynamically switching the instrumentation ON or OFF, according to one embodiment of the invention. As shown therein, the process begins in step 605, and advances to step 610 to measure a processor usage (PU) parameter. Then, the process advances to conditional step 615 to determine whether the PU is greater than a predetermined ceiling. If the determination in step 615 is in the affirmative, the process advances to step 620 to select one or more instruments for deactivation, then advances to step 625 to deactivate the selected instrument or instruments. Upon completion of deactivation step 625, the process returns to step 610 to measure the PU.

Where the determination in step 615 is in the negative, the process advances to conditional step 630 to determine whether a PU is less than a predetermined floor. If the determination in step 630 is in the affirmative, the process advances to step 635 to select one or more instruments for activation, and then advances to step 640 to activate the selected instrument or instruments. At the conclusion of step 640, the process returns to step 610 to measure the PU. In addition, where the determination in step 630 is in the negative, the process also advances to step 610.

Selection steps 620 and 635 may be performed, for example, according to a predetermined list of instrumentation priorities. Alternatively, or in combination, instrumentation priorities used in selection steps 620 and 635 can be dynamically determined according to measured performance data. In other embodiments, selection steps 620 and 635 can be performed manually.

Deactivation and activation steps 625 and 640, respectively can be performed using the process described above with reference to FIGS. 4 AND 5. For example, in one embodiment, step 640 includes sending an activation command to the collector object, causing a switch variable to be set in the appropriate IDS, reading the switch variable in the IDS, setting an internal flag to FALSE, and skipping recordation steps 520 and 535.

By deactivating instrumentation features when PU is high, and activating instrumentation features when PU is low, the negative effects of instrumentation on application performance are mitigated.

In alternative embodiments of dynamic or automatic operation, performance values other than PU are used. In addition, some embodiments may only produce activation or deactivation commands, but not both, according to ordinary design choice.

All of the processes described with reference to FIGS. 1, 2, 4, 5, and 6 can be implemented in processor-executable code, and the processor-executable code can be stored on a variety of processor-readable media such as Compact Disc Random Access Memory (CDROMs) or other storage devices. Moreover, a processor can be configured with processor-executable code to host the software architecture illustrated in FIG. 3 and/or to perform the processes depicted in FIGS. 1, 2, 4, 5, and 6.

### Benefits of the Described Instrumentation Architecture and Processes

In many instrumentations, a large majority of instrumentation overhead is related to message calls to the timer. Accordingly, the fact that such calls can be avoided (as illustrated in FIG. 5) means that instrumentation overhead is significantly reduced when the instrumented methods are turned OFF. All that remains during the OFF state is the single in-process call from the method to the associated IDS object to see whether or not collection should take place (e.g., step 510).

Moreover, even when instrumentation is turned ON, the overhead required by the instrumentation technique described herein is lower than alternative approaches. In one respect, overhead is reduced by minimizing calls to external objects. For example, by saving the result of conditional step 510 in a flag, an external call to the IDS is avoided in step 530 (since reading the flag set in step 515 only requires an internal call). In another respect, overhead is reduced by distributing performance data in the IDS objects. This is because there is less likelihood for data contention issues in a distributed data structure than in a centralized data structure. As a consequence, the overhead required to resolve such contentions is eliminated.

Another advantage of the disclosed instrumentation approach is that it is context sensitive: the ability to track performance is not only specific to the type of component instrumented, but, as noted above, methods can be selected for instrumentation based on the CONTEXT that the components operate in. For example, assume that a customer has written a “shopping cart” component. This component can be deployed in the same WebLogic application server in two contexts: one for a “Pet Store” eCommerce application, and one for a “Auction Site” application. These applications represent two separate and distinct uses of the shopping cart component. Accordingly, it is advantageous to track performance separately (and optionally) for different applications of the same components.

Embodiments of the invention described above may be performed on stand-alone computers or other processors. In the alternative, the processes may be executed in a network-based environment. As an example of the latter case, a user could download an instrumentation product from a Web site, perform an automated installation of instrumentation components, then configure the instrumented software using adapters for the specific resources (Web server, application server, database, etc.) the user wishes to monitor.

### Conclusion

In conclusion, embodiments of the invention provide, among other things, a system and method for dynamically scalable software instrumentation. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for instrumenting software for use in an object-oriented environment, comprising:
receiving compiled application code;
instrumenting the compiled application code, instrumenting including adding code to turn features of instrumentation ON and OFF;
loading the instrumented code; and
executing the loaded code.

2. The method of claim 1, wherein instrumenting includes adding a collector object and a plurality of instrument data structure objects.

3. The method of claim 2, further comprising:
registering a list of methods in the collector object;
associating a selected one of the plurality of instrument data structure objects with a selected method in the list of methods; and
registering the selected instrument data structure object in the collector object.

4. The method of claim 1, wherein instrumenting is selective, based on a predetermined description.

5. The method of claim 4, wherein the predetermined description is indicative of at least one method to be instrumented.

6. The method of claim 4, wherein the predetermined description is indicative of at least one class to be instrumented.

7. A program storage device readable by a machine, tangibly embodying a program of instructions executable by the machine to perform method steps for instrumenting software, said method steps comprising:
receiving compiled application code;
instrumenting the compiled application code, instrumenting including adding code to turn features of instrumentation ON and OFF;
loading the instrumented code; and
executing the loaded code.

8. A software instrumentation architecture, comprising:
a plurality of methods configured to perform monitoring functions, each of the plurality of methods associated with an application object;
a plurality of instrument data objects, each of the plurality of methods associated with at least one of the plurality of instrument data objects, each of the plurality of instrument data objects configured to receive and store performance data from associated methods; and
a collector object coupled to the plurality of instrument data objects.

9. The architecture in claim 8, wherein the monitoring functions include recording a start time and recording an end time.

10. The architecture in claim 8, wherein each of the plurality of instrument data objects include a switch variable, the switch variable controlling the activation state for each of the associated methods.

11. The architecture in claim 10, the collector object including an instrument method for setting the switch variable in each of the plurality of instrument data structure objects.

12. The architecture in claim 8, wherein the collector object includes a list, the list including a representation of associations between the plurality of methods and the plurality of instrument data objects.

13. The architecture in claim 12, the collector object including an interface to a console, the console configured to display the list.

14. A method for software instrumentation, comprising:
receiving a state command for a class, the class associated with a plurality of methods;
selecting one of a plurality of instrument data structure objects based on an association between the plurality of methods and plurality of instrument data structure objects;
sending a state message to the selected one of a plurality of instrument data structures, the state message based on the state command; and
setting a switch variable based on the state message.

15. A program storage device readable by a machine, tangibly embodying a program of instructions executable by the machine to perform method steps for instrumenting software, said method steps comprising:
receiving a state command for a class, the class associated with a plurality of methods;
selecting one of a plurality of instrument data structure objects based on an association between the plurality of methods and plurality of instrument data structure objects;
sending a state message to the selected one of a plurality of instrument data structures, the state message based on the state command; and
setting a switch variable based on the state message.

16. A method for software instrumentation, comprising:
determining whether to perform a monitoring function by reading a switch variable;
setting an flag to TRUE if the determination is in the affirmative;
recording a start time if the flag is TRUE;
executing application code associated with the monitoring function; and
recording an end time if the flag is TRUE.

17. The method of claim 16, wherein the switch variable is stored externally, and the flag is stored internally, with respect to a module performing the method.

18. The method of claim 16, wherein each of recording a start time and recording an end time include making a call external to a module performing the method.

19. The method of claim 16, further comprising calculating a run time based on the recorded start time and the recorded end time.

20. A program storage device readable by a machine, tangibly embodying a program of instructions executable by the machine to perform method steps for instrumenting software, said method steps comprising:
determining whether to perform a monitoring function by reading a switch;
setting an flag to TRUE if the determination is in the affirmative;
recording a start time if the flag is TRUE;
executing application code associated with the monitoring function; and
recording an end time if the flag is TRUE.

21. A method for software instrumentation, comprising:
measuring a performance parameter;
comparing the measured performance parameter to a predetermined upper threshold; and
deactivating at least a portion of software instrumentation if the performance parameter is greater than the predetermined upper threshold.

22. The method of claim 21, further comprising:
comparing the measured performance parameter to a predetermined lower threshold; and
activating at least a portion of software instrumentation if the performance parameter is less than the predetermined lower threshold.
